(19) United States
(12) Patent Application Publication
(10) Pub. No.: US 2021/0055720 A1
(43) Pub. Date: Feb. 25, 2021

(54) VEHICLE OPERATION SYSTEM

(71) Applicant: TOYOTA JIDOSHA KABUSHIKI KAISHA, Toyota-shi (JP)

(72) Inventors: Miyako HAYASHIDA, Miyoshi-shi (JP); Toshinari OGAWA, Nagoya-shi (JP); Kosuke FUJIMOTO, Nisshin-shi (JP); Hideo HASEGAWA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 16/928,534

(22) Filed: Jul. 14, 2020

(30) Foreign Application Priority Data
Aug. 21, 2019 (JP) 2019-151396

(51) Int. Cl. G05D 1/00; G05D 1/02; G01C 21/34

(52) U.S. Cl. CPC G05D 1/0011; G05D 1/0276; G01C 21/343; G01C 21/3461; G05D 1/0088

(57) ABSTRACT

A vehicle operation system, comprising a memory and a processor coupled to the memory, the processor being configured to: identify a current location of a vehicle; identify a vehicle model of the vehicle; cause the vehicle to travel by remote operation, by at least one of a plurality of operators; determine a travel experience level indicating a degree of travel experience of each of the plurality of operators with respect to the current location of the vehicle, and determine an operation experience level indicating a degree of operation experience of each of the plurality of operators with respect to the vehicle model of the vehicle; and after receiving remote operation request information from the vehicle, perform matching between a destination of the vehicle and travel experience levels and operation experience levels of the plurality of operators, so as to select an operator to perform remote operation of the vehicle.

### CROSS-REFERENCE TO RELATED APPLICATION

This application claims priority under 35 USC 119 from Japanese Patent application No. 2019-151396 filed on Aug. 21, 2019, the disclosure of which is incorporated by reference herein in its entirety.

### BACKGROUND

### Technical Field

The present disclosure relates to a vehicle operation system.

### Related Art

Japanese Patent Application Laid-Open (JP-A) No. 2018-180771 discloses an invention relating to a vehicle remote operation system. In this vehicle remote operation system, remote operation of a vehicle is performed using a remote operation device provided externally to the vehicle.

However, with the configuration disclosed in JP-A No. 2018-180771, it may be difficult to perform remote operation safely if an operating agent performing remote operation (hereafter referred to as an “operator” in order to distinguish from a driver on board the vehicle) has little travel experience of remote operation at the location where the vehicle is traveling. It may also be difficult to perform remote operation safely if the operator has little experience of operating the particular vehicle model. The technology of JP-A No. 2018-180771 therefore leaves room for improvement regarding these points.

### SUMMARY

The present disclosure obtains a vehicle operation system enabling remote operation of a vehicle to be safely performed.

A first aspect of the present disclosure is a vehicle operation system, comprising a memory and a processor coupled to the memory, the processor being configured to: identify a current location of a vehicle; identify a vehicle model of the vehicle; cause the vehicle to travel by remote operation, by at least one of a plurality of operators; determine a travel experience level indicating a degree of travel experience of each of the plurality of operators with respect to the current location of the vehicle, and determine an operation experience level indicating a degree of operation experience of each of the plurality of operators with respect to the vehicle model of the vehicle; and after receiving remote operation request information from the vehicle, perform matching between a destination of the vehicle and travel experience levels and operation experience levels of the plurality of operators, so as to select an operator to perform remote operation of the vehicle.

The vehicle operation system according to the first aspect includes a memory and a processor coupled to the memory. The processor identifies the current location of the vehicle. Moreover, the processor identifies the vehicle model of the vehicle. Furthermore, the processor causes the vehicle to travel by remote operation by at least one of plural operators. Moreover, the processor determines both the travel experience level and the operation experience level of the plural operators in performing remote vehicle operation. The travel experience level indicates the degree of travel experience of an operator for the current location of the vehicle, and the operation experience level indicates the degree of operation experience of an operator with respect to the vehicle model. The processor selects an operator to perform remote operation of the vehicle by performing matching between the destination of the vehicle and the travel experience levels and the operation experience levels of the plural operators when a remote operation request from the vehicle has been received. This enables an operator with both travel experience for the current location of the vehicle and operation experience with respect to the vehicle model of the vehicle to remotely operate the vehicle, enabling suppression of remote operation errors arising due to unfamiliarity with the location or unfamiliarity with the vehicle model.

Note that the “current location of the vehicle” includes not only the location where the vehicle is physically present, but also the vicinity of the location where the vehicle is physically present.

A second aspect of the present disclosure is the vehicle operation system of the first aspect, wherein: the processor is configured to acquire a current location of the vehicle after the processor has selected the operator, and to repeat determination of the travel experience level of each of the plurality of operators with respect to the current location of the vehicle as the current location of the vehicle changes; and the processor is configured to, after receiving the remote operation request information from the vehicle, repeatedly perform the matching between the destination of the vehicle and the travel experience levels and the operation experience levels of the plurality of operators as determined, and to replace the operator to perform remote operation of the vehicle as required.

According to the second aspect, the processor acquires the current location of the vehicle after the processor has selected the operator, and repeats determination of the travel experience level of each of the plural operators for the current location of the vehicle when the current location of the vehicle has changed. The processor repeats the matching after receiving the remote operation request from the vehicle. The matching is performed between the destination of the vehicle and the travel experience levels and the operation experience levels of the plural operators so as to replace the operator to perform remote operation of the vehicle as required. This enables cases such as when the vehicle is traveling long distance to be accommodated. Namely, even in cases in which the vehicle has moved to a location unfamiliar to the initial operator to perform remote operation due to, for example, traveling over a long distance, an operator who has travel experience for the new location can take over remote operation.

A third aspect of the present disclosure is the vehicle operation system of the first aspect or the second aspect, wherein the processor comprises: a first processor that causes the vehicle to travel by remote operation; and a second processor installed at the vehicle, wherein the first processor is configured to present remote operation guidance to the operator when an occupant of the vehicle has requested remote operation, the remote operation guidance reflecting a preference condition of the occupant with respect to remote operation, and the preference condition being acquired from the second processor, which is configured to acquire the preference condition.

According to the third aspect, the first processor supplies the operator with the remote operation guidance reflecting the preference condition of the occupant with respect to remote operation, which has been acquired from the second processor, thereby enabling the operator to check the remote operation guidance and perform remote operation of the vehicle based on the preference condition. This enables the level of satisfaction of the occupant during remote operation of the vehicle to be increased.

As described above, the vehicle operation system according to the first aspect enables remote operation of the vehicle to be safely performed.

The vehicle operation system according to the second aspect enables long distance travel of the vehicle to be accommodated.

The vehicle operation system according to the third aspect enables the comfort level of the occupant during remote operation of the vehicle to be increased.

### BRIEF DESCRIPTION OF THE DRAWINGS

An exemplary embodiment of the present disclosure will be described in detail based on the following figures, wherein:

FIG. 1 is a schematic diagram illustrating a vehicle operation system according to an exemplary embodiment;

FIG. 2 is a schematic diagram illustrating transition to remote operation in a vehicle operation system according to an exemplary embodiment;

FIG. 3 is a block diagram illustrating hardware configuration of a vehicle of a vehicle operation system according to an exemplary embodiment;

FIG. 4 is a block diagram illustrating hardware configuration of a control center of a vehicle operation system according to an exemplary embodiment;

FIG. 5 is a block diagram illustrating hardware configuration of a server of a vehicle operation system according to an exemplary embodiment;

FIG. 6 is a block diagram illustrating functional configuration of a vehicle operation system according to an exemplary embodiment; and

FIG. 7 is a flowchart illustrating a flow of operation of a vehicle operation system according to an exemplary embodiment.

### DETAILED DESCRIPTION

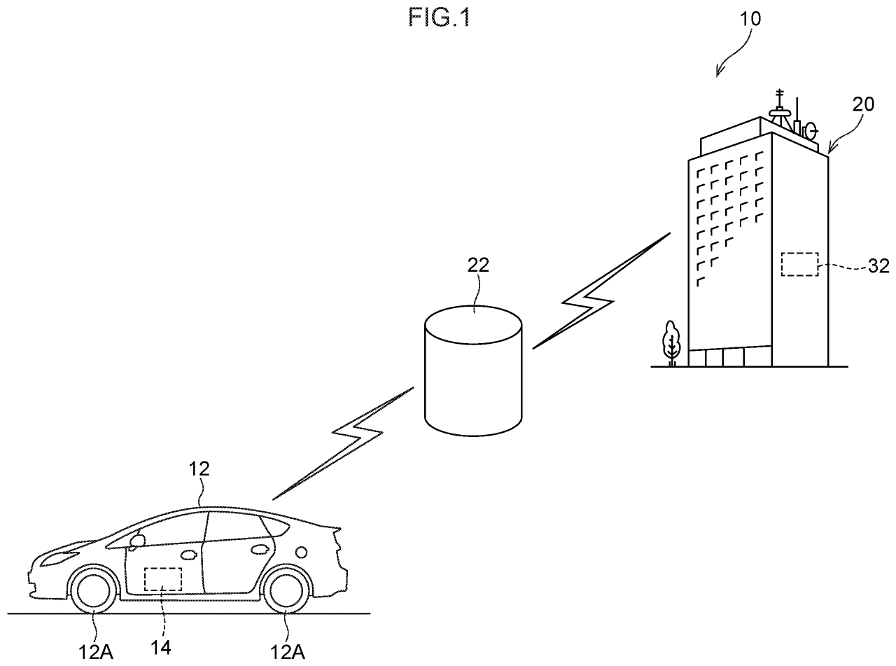

Explanation follows regarding an exemplary embodiment of a vehicle operation system 10 according to the present disclosure, with reference to FIG. 1 to FIG. 7.

Overall Configuration

FIG. 1 is a diagram schematically illustrating configuration of the vehicle operation system 10 according to the present exemplary embodiment.

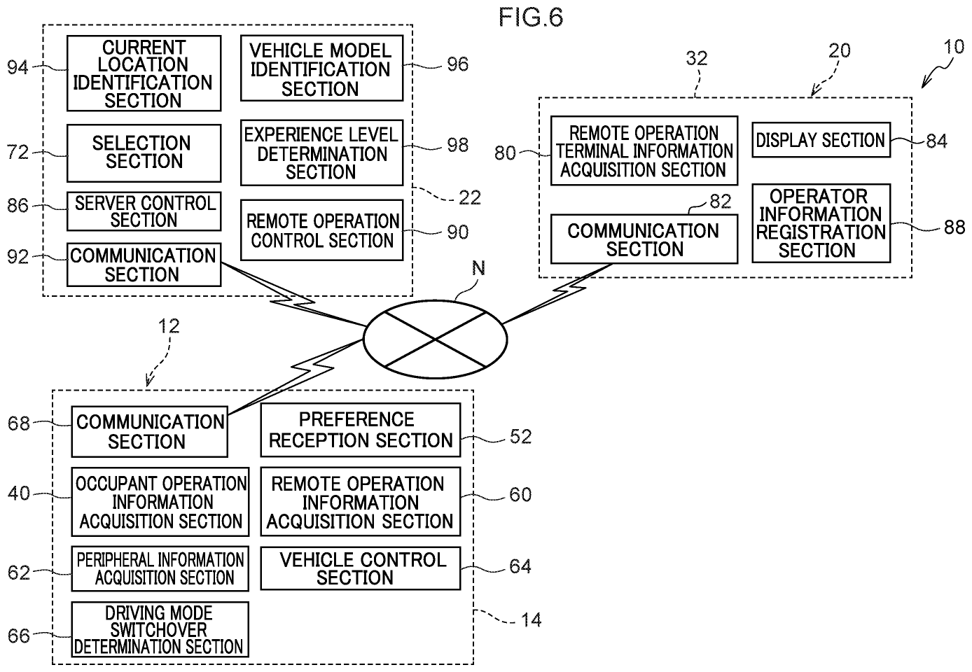

As illustrated in FIG. 1, the vehicle operation system 10 is configured including an onboard unit 14 installed in a vehicle 12, a control center 20, and a server 22. The onboard unit 14, the control center 20, and the server 22 are connected so as to be capable of communicating with each other through a network N (see FIG. 6). For example, the internet or a wide area network (WAN) is applied as the network N.

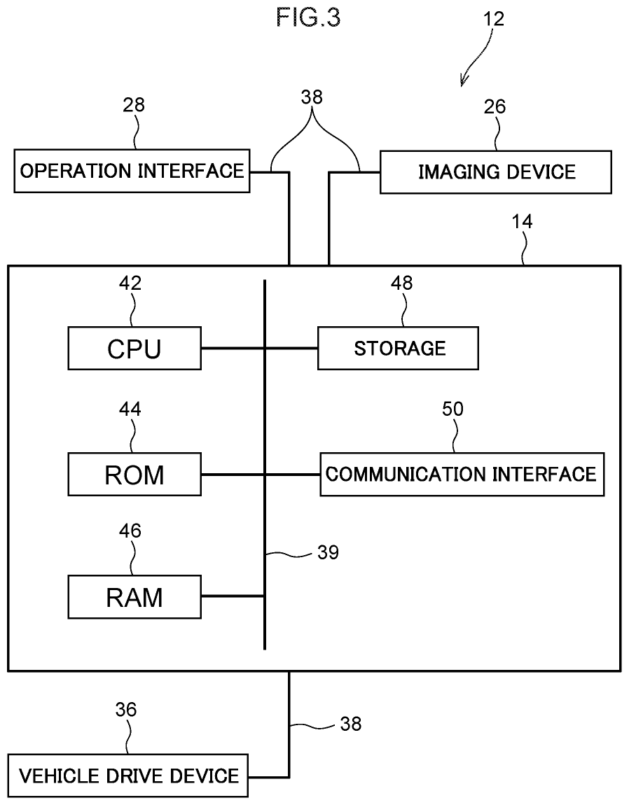

As an example, the vehicle 12 is a private car belonging to a non-illustrated user, and is capable of being manually driven using an operation interface 28 (see FIG. 3) inside the vehicle, and also of being remotely operated from the control center 20 using images from an imaging device 26 (see FIG. 3). The onboard unit 14 is capable of transmitting a usage status and a vehicle state of the vehicle 12 to the server 22 provided externally to the vehicle. Configuration and operation of the onboard unit 14 are described in detail later.

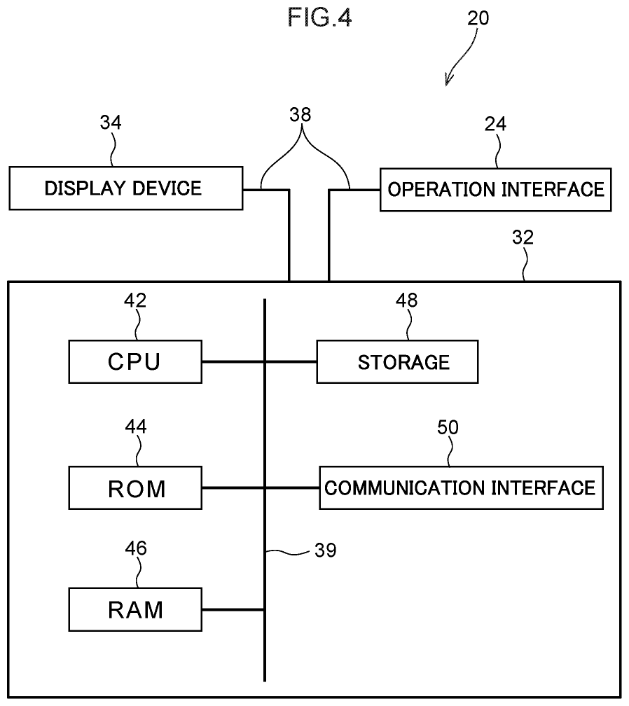

The control center 20 is provided with an operation interface 24 for remotely operating the vehicle 12, a remote operation information acquisition device 32, a display device 34 (see FIG. 4), and the server 22 (the server 22 and the control center 20 are illustrated separately from each other in FIG. 1 in order to facilitate understanding of the main configuration). The server 22 gathers various information from the onboard unit 14 and the remote operation information acquisition device 32, manages this gathered information in a database, and transmits various information. Configuration and operation of the operation interface 24, the remote operation information acquisition device 32, the display device 34, and the server 22 are described in detail later.

Hardware Configuration

As illustrated in FIG. 3, the vehicle 12 includes the operation interface 28, the imaging device 26, the onboard unit 14, and a vehicle drive device 36. These configuration sections are connected so as to be capable of communicating with each other through a bus 38.

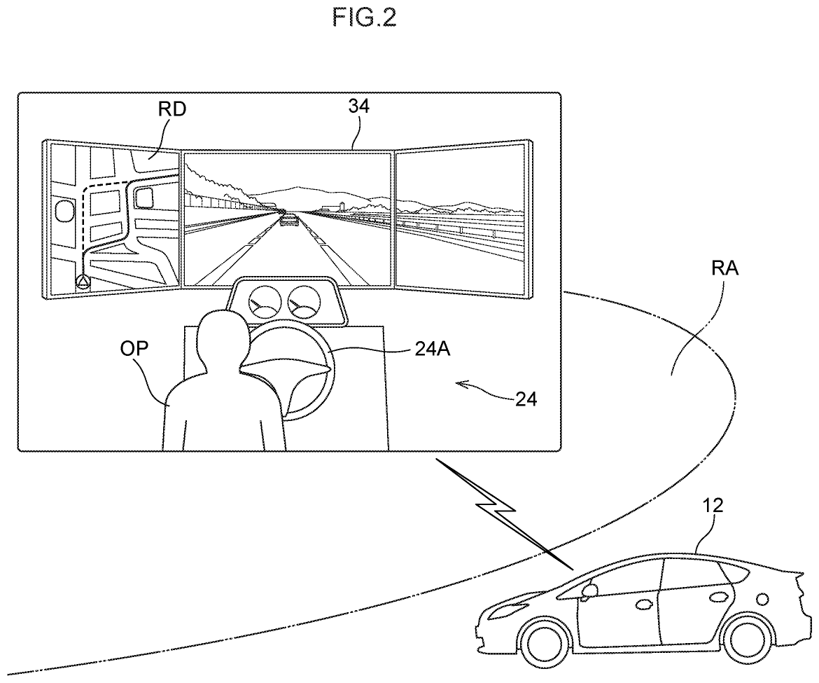

The operation interface 28 is disposed toward the vehicle front side in a vehicle cabin of the vehicle 12, and is configured including a steering wheel, an accelerator pedal, a brake pedal, a gear shift lever, a driving mode switchover switch, and a car navigation device (none of which are illustrated in the drawings). The operation interface 28 is connected to an occupant operation information acquisition section 40 (see FIG. 6), described later, of the onboard unit 14. Note that the driving mode switchover switch is a switch for switching between manual driving in which the vehicle 12 is driven by an occupant and remote operation of the vehicle 12 by an operator OP (see FIG. 2) at the control center 20. When the driving mode switchover switch is operated in order to implement remote operation, if possible, a switchover is made to remote operation after processing, described later, has been performed at the control center 20 and in the server 22.

As an example, the car navigation device of the operation interface 28 is a liquid crystal display including a touch panel capable of being touch-operated by the occupant. When the occupant has operated the driving mode switchover switch in order to implement remote operation, the car navigation device acquires a destination and preference conditions for remote operation. Specifically, a remote operation destination, a preferred travel route, desired waypoints, movement speed, and the like can be input as preference conditions. The input preference conditions are sent to the onboard unit 14.

As an example, the imaging device 26 is provided inside the vehicle cabin of the vehicle 12, and captures a scene outside the vehicle centered straight ahead of the vehicle 12. The captured images are sent to the onboard unit 14.

The onboard unit 14 is configured including a central processing unit (CPU) 42, read only memory (ROM) 44, random access memory (RAM) 46, storage 48, and a communication interface 50. These configuration sections are connected so as to be capable of communicating with each other through a bus 39.

The CPU 42 is a central processing unit that executes various programs and controls various sections. Namely, the CPU 42 reads a program from the ROM 44 or the storage 48, and executes the program using the RAM 46 as a workspace. The CPU 42 controls the respective configuration sections and performs various arithmetic processing according to the program recorded in the ROM 44 or the storage 48. In the present exemplary embodiment, a vehicle operation program is held in the ROM 44 or the storage 48.

The ROM 44 holds various programs and various data. The RAM 46 serves as a workspace to temporarily store programs or data. The storage 48 is configured by a hard disk drive (HDD) or a solid state drive (SSD), and holds various programs including an operating system, and various data.

The communication interface 50 is an interface used by the onboard unit 14 to communicate with the server 22, and employs a protocol such as Ethernet (registered trademark), FDDI, or Wi-Fi (registered trademark).

The vehicle drive device 36 activates a non-illustrated motor to drive wheels 12A (see FIG. 1) of the vehicle 12 based on control by the onboard unit 14.

As illustrated in FIG. 4, the operation interface 24, the display device 34, and the remote operation information acquisition device 32 of the control center 20 are connected so as to be capable of communicating with each other through a bus 38. As an example, the operation interface 24 is configured from a remote steering wheel 24A (see FIG. 2), a remote accelerator pedal, a remote brake pedal, and a remote gear shift lever (none of which are illustrated in the drawings), and are provided in order for the operator OP (see FIG. 2) at the control center 20 to perform remote operation of the vehicle 12. As an example, the operation interface 24 is allocated to one of plural operators OP on stand-by at the control center 20. Note that the operation interface 24 may be configured including a keyboard, mouse, and joystick (none of which are illustrated in the drawings).

The remote operation information acquisition device 32 is configured including a CPU 42, ROM 44, RAM 46, storage 48, and a communication interface 50. These configuration sections are connected so as to be capable of communicating with each other through a bus 39. The remote operation information acquisition device 32 transmits operation information input using the operation interface 24 for remote operation of the vehicle 12 to the server 22.

The display device 34 configures a display (see FIG. 2) for displaying information received from the server 22. Specifically, displayable information includes peripheral images acquired by the vehicle 12, and the preference conditions input to the car navigation device (in FIG. 2, remote operation guidance RD reflecting a preference condition of a preferred travel route of the occupant is displayed as an example). As an example, the display device 34 is allocated to one of the plural operators OP on stand-by at the control center 20.

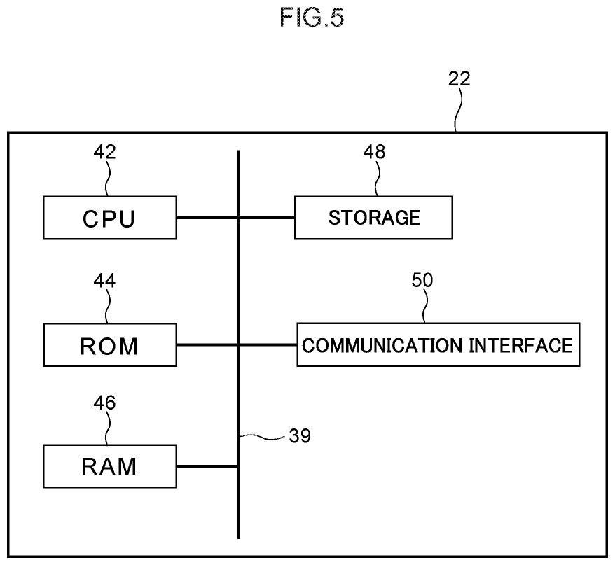

As illustrated in FIG. 5, the server 22 is configured including a CPU 42, ROM 44, RAM 46, storage 48, and a communication interface 50. These configuration sections are connected so as to be capable of communicating with each other through a bus 39.

Functional Configuration

When the above-mentioned vehicle operation program is executed, the vehicle operation system 10 employs the above-described hardware resources to implement various functionality. Explanation follows regarding functional configuration implemented by the vehicle operation system 10.

FIG. 6 is a block diagram illustrating an example of the functional configuration of the vehicle operation system 10.

Functional Configuration of Vehicle

As illustrated in FIG. 6, as functional configuration of the vehicle 12, the vehicle operation system 10 includes the occupant operation information acquisition section 40, a remote operation information acquisition section 60, a peripheral information acquisition section 62, a preference reception section 52, a vehicle control section 64, a driving mode switchover determination section 66, and a communication section 68. This functional configuration is implemented by the CPU 42 of the onboard unit 14 reading and executing the vehicle operation program stored in the ROM 44 or the storage 48.

The occupant operation information acquisition section 40 acquires operation information input to the operation interface 28 (see FIG. 3) by an occupant on board the vehicle 12.

The remote operation information acquisition section 60 controls the communication section 68 so as to acquire operation information transmitted from the server 22. The operation information transmitted from the server 22 is operation information input to the operation interface 24 (see FIG. 4) by the operator OP at the control center 20.

The vehicle control section 64 controls driving and steering of the vehicle drive device 36 (see FIG. 2) based on the operation information acquired by the occupant operation information acquisition section 40 or the remote operation information acquisition section 60.

The peripheral information acquisition section 62 acquires the images captured by the imaging device 26 (see FIG. 3) provided to the vehicle 12, and various information, such as current location information, vehicle model information, travel history including dates and times, total distance traveled, fuel level, various oil levels, and tire pressure, from various non-illustrated sensors. The peripheral information acquisition section 62 also controls the communication section 68 in order to transmit this various information to the server 22.

When the occupant has operated the driving mode switchover switch in order to implement remote operation, the preference reception section 52 acquires the destination, preferred travel route during remote operation, desired waypoints, movement speed, and so on input to the car navigation device of the vehicle 12, and controls the communication section 68 so as to transmit this information to the server 22.

The driving mode switchover determination section 66 acquires a state of the driving mode switchover switch of the vehicle 12. When the driving mode switchover switch is in a state switched to remote operation, the driving mode switchover determination section 66 deems the occupant to be requesting remote operation, and controls the communication section 68 so as to transmit remote operation request information to the server 22.

The communication section 68 exchanges information with other devices.

Functional Configuration of Control Center

As functional configuration of the control center 20, the vehicle operation system 10 includes a remote operation terminal information acquisition section 80, a communication section 82, a display section 84, and an operator information registration section 88. This functional configuration is implemented by the CPU 42 of the remote operation information acquisition device 32 reading and executing the vehicle operation program stored in the ROM 44 or the storage 48.

The remote operation terminal information acquisition section 80 acquires operation information from the operation interface 24 (see FIG. 4) allocated to an operator OP selected by the server 22 from out of the plural operators OP to perform remote operation (hereafter referred to as the selected operator OP in order to differentiate from other operators OP), as described later, and controls the communication section 82 so as to transmit this operation information to the server 22.

The display section 84 controls the display device 34 (see FIG. 4) allocated to the selected operator OP selected by the server 22 so as to display various information received by the server 22 from the peripheral information acquisition section 62 of the vehicle 12 to the selected operator OP.

The operator information registration section 88 acquires various information such as remote operation availability information, travel history, and operation history relating to each of the plural operators OP on stand-by at the control center 20.

The communication section 82 exchanges information with other devices.

Functional Configuration of Server

As functional configuration of the server 22, the vehicle operation system 10 includes a server control section 86, a current location identification section 94, a vehicle model identification section 96, a remote operation control section 90, an experience level determination section 98, a selection section 72, and a communication section 92. This functional configuration is implemented by the CPU 42 of the server 22 reading and executing the vehicle operation program stored in the ROM 44 or the storage 48.

The current location identification section 94 identifies the current location of the vehicle 12 (hereafter simply referred to as the current location) from the current location information acquired from the peripheral information acquisition section 62 of the vehicle 12.

The vehicle model identification section 96 identifies the model of the vehicle 12 from the vehicle model information acquired from the peripheral information acquisition section 62 of the vehicle 12.

The experience level determination section 98 acquires the current location from the current location identification section 94 and also acquires information regarding the model of the vehicle 12 from the vehicle model identification section 96. The experience level determination section 98 also acquires various information relating to plural operators OP who are registered in the operator information registration section 88 and are in a state capable of performing remote operation of the vehicle 12 at the control center 20 (hereafter simply referred to as the plural operators OP), and for each of the plural operators OP, determines a travel experience level indicating the degree of travel experience for the current location. Namely, as an example, the travel experience of each of the operators OP is computed by the experience level determination section 98 as information relating to past remote operation history and the day-to-day travel range of the operator OP, and positional information based on pre-registered information such as roads and locations for which the operator OP has actual vehicle driving experience. The experience level determination section 98 then compares the travel experience of each of the operators OP for the current location, and ranks the operators OP in sequence from most to least traveling experience for the current location. Note that when ranking travel experience for the current location, time spent traveling at the current location, distance traveled at the current location, a combination thereof, or another parameter may be employed.

The experience level determination section 98 also determines an operation experience level indicating a degree of operation experience of each of the plural operators OP. Namely, as an example, the operation experience of each operator OP may be computed as time information based on past remote operation history and vehicle model information relating to this remote operation. The experience level determination section 98 then compares the operation experience level of each operator OP against the model of the vehicle 12, and ranks the operators OP in sequence from most to least experience in operating the vehicle model corresponding to the vehicle 12. Note that when ranking experience in operating the vehicle model, time spent traveling in this vehicle model, distance traveled in this vehicle model, a combination thereof, or another parameter may be employed.

As an example, on receipt of the remote operation request information, the selection section 72 acquires the current location from the current location identification section 94, and determines whether or not the vehicle 12 is within a remote operation service area RA (see FIG. 2), or whether or not the vehicle 12 is traveling toward the remote operation service area RA and is near to the remote operation service area RA (hereafter simply referred to as being near to the remote operation service area RA). In cases in which the vehicle 12 is within the remote operation service area RA or near to the remote operation service area RA and the remote operation request information has been received, the selection section 72 performs matching to select an operator OP to perform remote operation of the vehicle 12. Specifically, the selection section 72 compares the operator OP travel experience level ranking against the operator OP operation experience level ranking acquired from the experience level determination section 98, and, from the plural operators OP, selects an operator who is ranked highly in each of these rankings as the selected operator OP to perform remote operation of the vehicle 12. The selection section 72 performs control to display various information from the peripheral information acquisition section 62 of the vehicle 12 on the display device 34 of the selected operator OP, and controls the remote operation terminal information acquisition section 80 so as to acquire operation information from the operation interface 24 allocated to the selected operator OP.

Note that even after the selection section 72 has selected an operator OP, the experience level determination section 98 continues to acquire the current location from the current location identification section 94, acquire the various information relating to the plural operators OP, and determine the travel experience level of each of the plural operators OP for the current location. Namely, even when the current location changes due to the movement of the vehicle 12, the travel experience level of each of the plural operators OP for the current location is still determined. As long as the vehicle 12 remains within the remote operation service area RA or near to the remote operation service area RA and the remote operation request information has been received (as long as a state in which the driving mode switchover switch is switched to performing remote operation is maintained), the selection section 72 repeats the matching to select an operator OP to perform remote operation of the vehicle 12. In cases in which an operator OP is present who has a higher travel experience level ranking than the previously selected operator OP for the current location (such an operator OP is hereafter referred to as the replacement operator OP so as to distinguish the replacement operator OP from the selected operator OP), the replacement operator OP takes over as the operator OP to perform remote operation of the vehicle 12. The selection section 72 then performs control to display the various information from the peripheral information acquisition section 62 of the vehicle 12 on the display device 34 of the replacement operator OP. A switchover is also performed at a predetermined timing so as to acquire operation information from the operation interface 24 allocated to the replacement operator OP instead of from the operation interface 24 allocated to the selected operator OP.

The remote operation control section 90 acquires operation information from the selected operator OP or the replacement operator OP selected by the selection section 72. The remote operation control section 90 also controls the server control section 86 so as to transmit the acquired operation information to the vehicle 12.

The server control section 86 controls the server 22. For example, the server control section 86 acquires various information transmitted from the vehicle 12, controls the communication section 92 so as to transmit this information to the control center 20, and also controls the communication section 92 so as to transmit various information from the control center 20 to the vehicle 12.

The communication section 92 exchanges information with other devices.

Processing Flow

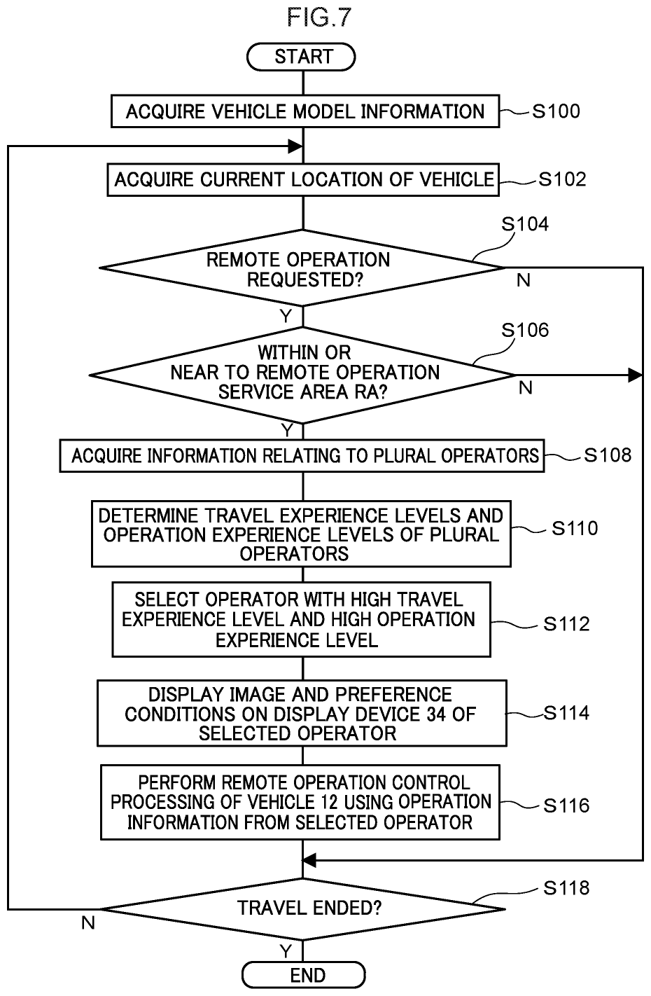

Explanation follows regarding operation of the vehicle operation system 10. FIG. 7 is a flowchart illustrating a flow of operation by the vehicle operation system 10. The respective CPUs 42 of the onboard unit 14, the remote operation information acquisition device 32, and the server 22 read the vehicle operation program from the corresponding ROM 44 or storage 48, and expand and execute the program in the corresponding RAM 46 to perform this processing.

The CPU 42 acquires the vehicle model information of the vehicle 12 (step S100) and acquires the current location information of the vehicle 12 (step S102). The CPU 42 then determines whether or not the remote operation request information has been received (step S104). In cases in which the remote operation request information has not been received (step S104: NO), the CPU 42 transitions to the processing of step S118, described later. In cases in which the remote operation request information has been received (step S104: YES), the CPU 42 determines whether or not the vehicle 12 is within the remote operation service area RA or near to the remote operation service area RA (step S106). In cases in which the vehicle 12 is neither within the remote operation service area RA nor near to the remote operation service area RA (step S106: NO), the CPU 42 transitions to the processing of step S118.

In cases in which the vehicle 12 is within the remote operation service area RA or near to the remote operation service area RA (step S106: YES), the CPU 42 acquires information relating to the plural operators OP at the control center 20 (step S108), determines the travel experience level and operation experience level of each of the plural operators OP based on the acquired information (step S110), and selects an operator OP who has both a high travel experience level and a high operation experience level as the selected operator OP (or a replacement operator OP) to perform remote operation of the vehicle 12 (step S112).

The CPU 42 displays an image from the imaging device 26 of the vehicle 12 and the remote operation guidance RD reflecting the preference conditions acquired from the preference reception section 52 on the display device 34 allocated to the selected operator OP (or the replacement operator OP) (see FIG. 2; step S114), and performs remote operation control processing of the vehicle 12 according to operation information input to the operation interface 24 by the selected operator OP (or the replacement operator OP) (step S116).

The CPU 42 determines whether or not travel of the vehicle 12 has ended due to for example arrival at the destination or a power unit switch of the vehicle 12 being switched off (step S118). In cases in which travel of the vehicle 12 has not ended (step S118: NO), the CPU 42 returns to the processing of step S102. By repeating the above-described processing, replacement operators OP are selected in response to the continually changing current location. In cases in which travel of the vehicle 12 has ended (step S118: YES), the CPU 42 ends the processing based on the vehicle operation program.

### Operation and Advantageous Effects

Explanation follows regarding operation and advantageous effects of the present exemplary embodiment.

As illustrated in FIG. 6, in the present exemplary embodiment the vehicle operation system 10 includes the current location identification section 94, the vehicle model identification section 96, the remote operation control section 90, the experience level determination section 98, and the selection section 72. The current location identification section 94 identifies the current location of the vehicle 12. The vehicle model identification section 96 identifies the model of the vehicle 12. The remote operation control section 90 causes the vehicle 12 to travel by the remote operation of the selected operator OP or the replacement operator OP from out of the plural operators OP. The experience level determination section 98 determines the travel experience level and the operation experience level of each of the plural operators OP that are in a state capable of remotely operating the vehicle 12. The travel experience level indicates the degree of travel experience of each operator OP for the current location of the vehicle 12, and the operation experience level indicates the degree of operation experience of each operator OP with respect to the model of the vehicle 12. When a remote operation request has been received from the vehicle 12, the selection section 72 performs matching between the destination of the vehicle 12 and the travel experience level and the operation experience level of each of the plural operators OP in order to select a selected operator OP to perform remote operation of the vehicle 12. This enables an operator OP with both travel experience for the current location of the vehicle 12 and operation experience of the model of the vehicle 12 to perform the remote operation of the vehicle 12, thereby enabling remote operation errors arising due to unfamiliarity with the location or unfamiliarity with the vehicle model to be suppressed. This enables remote operation of the vehicle 12 to be safely performed.

Moreover, even after the selection section 72 has selected the selected operator OP, the experience level determination section 98 continues to acquire the current location of the vehicle 12 from the current location identification section 94, and repeats determination of the travel experience level of each of the plural operators OP for the current location as the current location changes. As long as the remote operation request is being received from the vehicle 12, the selection section 72 repeats matching of the destination against the travel experience level and operation experience level of each of the plural operators OP, and replaces the selected operator OP performing remote operation of the vehicle 12 (namely, selects a replacement operator OP) as required, thereby enabling cases such as when the vehicle 12 is traveling long distance to be accommodated. Namely, even in cases in which the vehicle 12 has moved to a location unfamiliar to the initial selected operator OP performing remote operation due to for example traveling over a long distance, a replacement operator OP who has travel experience for the new location can take over remote operation. This enables long distance travel of the vehicle 12 to be accommodated.

Furthermore, the remote operation control section 90 supplies the remote operation guidance RD (see FIG. 2), reflecting the preference conditions of the occupant with respect to remote operation, to the selected operator OP (or the replacement operator OP), thereby enabling the selected operator OP (or the replacement operator OP) to check the remote operation guidance RD and perform remote operation of the vehicle 12 based on the preference conditions. This enables the level of satisfaction of the occupant during remote operation of the vehicle 12 to be increased. This in turn enables the comfort level of the occupant during remote operation of the vehicle 12 to be increased.

Note that although the present exemplary embodiment is configured such that the selected operator OP performing remote operation of the vehicle 12 is replaced as required within the remote operation service area RA, there is no limitation thereto. For example, in cases in which the remote operation service area RA is limited to a specific area, for example a sightseeing location or a theme park such as a safari park, configuration may be made such that once a selected operator OP has been selected, the operator OP is not replaced while within the specific area.

Moreover, although preference conditions of the occupant are acquired by the preference reception section, there is no limitation thereto. A configuration may be applied in which the preference reception section is not provided, and a travel route or the like for remote operation by the operator OP is proposed to the occupant for the occupant to either accept or reject. Furthermore, a configuration may be applied in which the server 22 selects an optimal travel route, travel speed, and so on, and supplies this to the operator OP who is to perform remote operation as remote operation guidance RD.

Furthermore, although the plural operators OP are each allocated an operation interface 24 and a display device 34, there is no limitation thereto. A configuration may be applied in which a predetermined number of operation interfaces 24 and display devices 34 are used in turn by selected operators OP and replacement operators OP when actually performing operation.

An exemplary embodiment of the present disclosure has been described above. However, the present disclosure is not limited to the above description, and obviously various other modifications may be implemented within a range not departing from the spirit of the present disclosure.

What is claimed is:

1. A vehicle operation system, comprising
a memory and
a processor coupled to the memory, the processor being configured to:
identify a current location of a vehicle;
identify a vehicle model of the vehicle;
cause the vehicle to travel by remote operation, by at least one of a plurality of operators;
determine a travel experience level indicating a degree of travel experience of each of the plurality of operators with respect to the current location of the vehicle, and determine an operation experience level indicating a degree of operation experience of each of the plurality of operators with respect to the vehicle model of the vehicle; and
after receiving remote operation request information from the vehicle, perform matching between a destination of the vehicle and travel experience levels and operation experience levels of the plurality of operators, so as to select an operator to perform remote operation of the vehicle.

2. The vehicle operation system of claim 1, wherein:
the processor is configured to acquire a current location of the vehicle after the processor has selected the operator, and to repeat determination of the travel experience level of each of the plurality of operators with respect to the current location of the vehicle as the current location of the vehicle changes; and
the processor is configured to, after receiving the remote operation request information from the vehicle, repeatedly perform the matching between the destination of the vehicle and the travel experience levels and the operation experience levels of the plurality of operators as determined, and to replace the operator to perform remote operation of the vehicle as required.

3. The vehicle operation system of claim 1, wherein the processor comprises:
a first processor that causes the vehicle to travel by remote operation; and
a second processor installed at the vehicle,
wherein the first processor is configured to present remote operation guidance to the operator when an occupant of the vehicle has requested remote operation, the remote operation guidance reflecting a preference condition of the occupant with respect to remote operation, and the preference condition being acquired from the second processor, which is configured to acquire the preference condition.

4. The vehicle operation system of claim 1, wherein the processor is configured to rank the plurality of operators in sequence from most to least travel experience for the current location of the vehicle, based on at least one type of information among information relating to past remote operation history and a day-to-day travel range for the plurality of operators, or pre-registered information relating to roads and locations of actual vehicle driving experience for the plurality of operators.

5. The vehicle operation system of claim 1, wherein the processor is configured to rank the plurality of operators in sequence from most to least experience of operating the vehicle model of the vehicle based on time spent traveling for respective vehicle models as computed using past remote operation history for the plurality of operators.

6. The vehicle operation system of claim 3, wherein the second processor is configured to acquire a preferred travel route, a desired waypoint, and a movement speed for remote operation.
